(19) United States
(12) Patent Application Publication
(10) Pub. No.: US 2011/0017373 A1
(43) Pub. Date: Jan. 27, 2011

(54) Anti-Slip Tread Pattern for Shoes

(76) Inventor: Gap Jin Lee, Cheonan-Si (KR)

Correspondence Address: FULBRIGHT AND JAWORSKI LLP, 555 S. FLOWER STREET, 41ST FLOOR, LOS ANGELES, CA, 90071, US

(21) Appl. No.: 12/510,044

(22) Filed: Jul. 27, 2009

(51) Int. Cl. B60C 11/13

(52) U.S. Cl. 152/209.18

(57) ABSTRACT

An exemplary tread configuration having improved slip-resistance includes a tread element having a length and a width. The tread element also includes a long longitudinal groove extending a substantial length of the tread element and a long latitudinal groove extending a substantial width of the tread element. Additionally, the tread element includes at least two short longitudinal grooves extending a fraction of the length of the tread element and aligned substantially parallel to the long longitudinal groove. At least one of the at least two short longitudinal grooves is located each side of the long longitudinal groove. The tread element further includes at least two short latitudinal grooves extending a fraction of the width of the of the tread element and aligned substantially parallel to the long latitudinal groove. At least one of the at least two short latitudinal grooves is located on each side of the long latitudinal groove.

### TECHNICAL FIELD

The present invention generally relates to tread construction. More specifically, the present disclosure relates to improved slip-resistant tread configurations.

### BACKGROUND

Many hazards exist in a workplace environment for employees, and reducing hazards is an ongoing concern for employers and employees alike. One such hazard is slippery floor hazards. Slippery floor hazards may be found in nearly any facility. For example water and other slippery substances are frequently used in restaurants, kitchens, hospitals, medical facilities, industrial operations, and manufacturing operations. An employee in any position at any of these facilities may encounter a slippery floor hazard resulting in a slip-and-fall incident. In addition to injury, productivity and morale at the facility decrease as a result of injuries from slippery floor hazards.

Slip-resistance footwear is especially important in facilities with slippery floor hazards. Although all footwear provides some slip-resistance, increasing the slip-resistance capability of a shoe may reduce likelihood of slip-and-fall incidence and work-place injuries related to slippery floor hazards.

Slippery floor hazards are not restricted to work place environments. Home environments also include slippery floor hazards in kitchens, garages, sidewalks, patios, and decks. Additionally, improved slip-resistance technology increase safety in other industries. For example, tires may hydroplane on wet surfaces when traction with the road is lost resulting in automobile collisions. Additionally, crutch tips may lose traction with the ground in slippery floor hazards.

### BRIEF SUMMARY

According to one aspect of the disclosure, a tread element includes a tread element unit having a length and a width with a long longitudinal groove extending along a substantial length of the tread element unit. The tread element also includes a long latitudinal groove extending along a substantial width of the tread element unit. The tread element further includes at least two short longitudinal grooves extending a fraction of the length of the tread element unit and aligned substantially parallel to the long longitudinal groove. At least one of the at least two short longitudinal grooves being positioned on each side of the long longitudinal groove. The tread element yet also includes at least two short latitudinal grooves extending a fraction of the width of the of the tread element unit and aligned substantially parallel to the long latitudinal groove. At least one of the at least two short latitudinal grooves being on each side of the long latitudinal groove.

According to another aspect of the disclosure, a tread element includes at least two inner tread blocks. The tread element also includes at least four outer tread blocks adjacent to the at least two inner tread blocks and arranged to substantially surround the at least two inner tread blocks.

The foregoing has outlined rather broadly the features and technical advantages of the present invention in order that the detailed description that follows may be better understood. Additional features and advantages will be described hereinafter which form the subject of the claims of the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the technology of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following description taken in conjunction with the accompanying drawings.

FIG. 1 is a perspective view of an exemplary tread configuration having improved slip-resistance according to one embodiment of the disclosure.

FIG. 2 is a perspective view of an array of exemplary tread elements having improved slip-resistance according to one embodiment of the disclosure.

### DETAILED DESCRIPTION

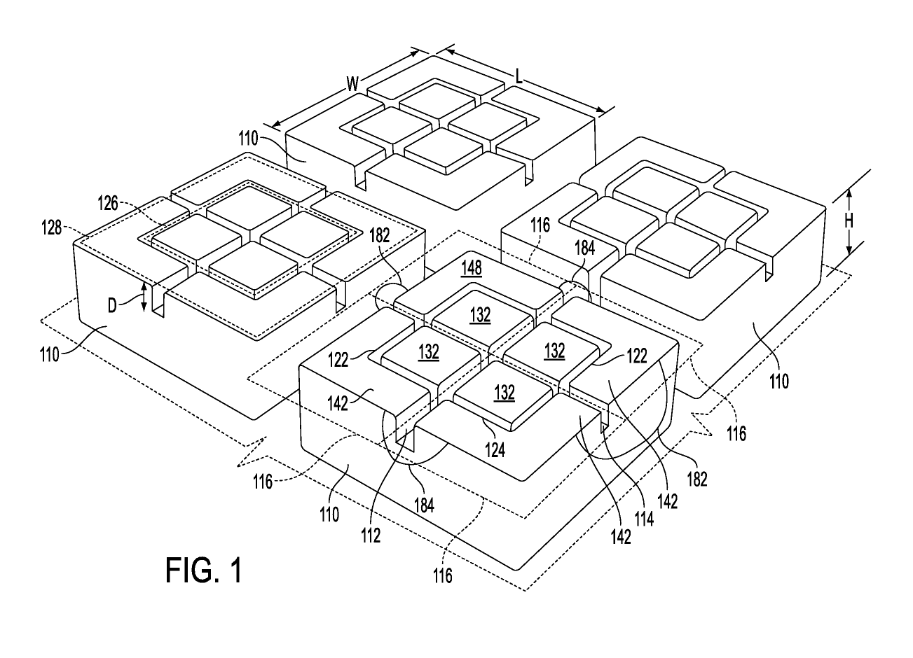

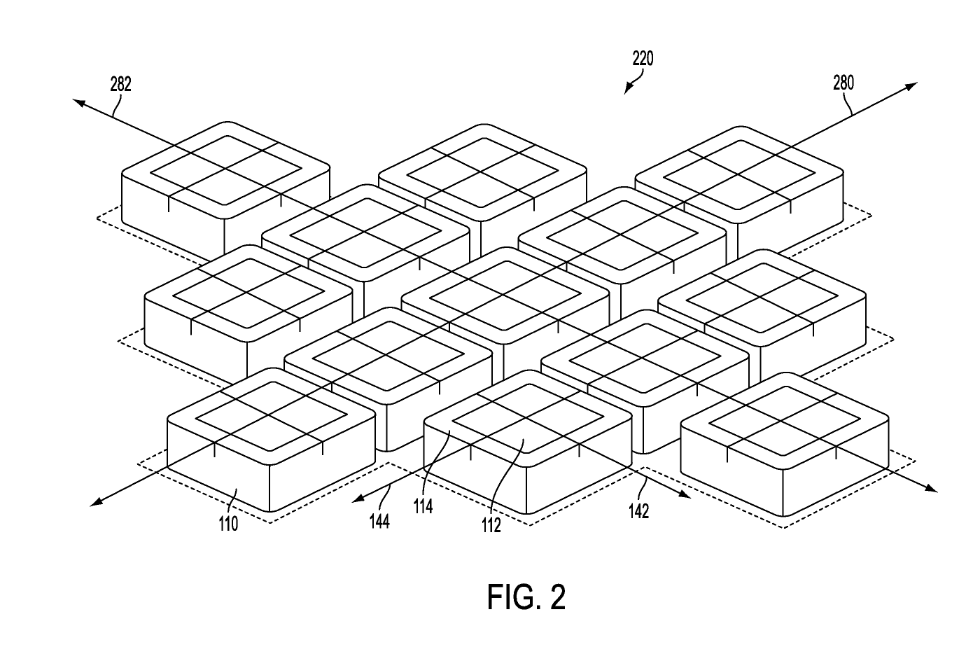

Improving slip-resistance of tread configurations decreases slip-and-fall incidents and improves the safety of employees at corporate facilities and individuals in their homes. Additionally, improved slip-resistance of tread configurations increases traction of tires with the ground and decreases hydroplaning incidents in wet weather or in oil slicks on roads. An exemplary tread configuration having improved slip-resistance according to one embodiment will now be described with reference to FIGS. 1-2.

FIG. 1 is a perspective view of an exemplary tread configuration having improved slip-resistance according to one embodiment of the disclosure. A tread element 110 includes a long longitudinal groove 112 extending a substantial length of the tread element 110. According to one embodiment, the long longitudinal groove 112 is aligned substantially parallel with edges 182 of the tread element 110. In another embodiment, the long longitudinal groove 112 extends the entire length of the tread element 110. Additionally, the tread element 110 includes a long latitudinal groove 114, which intersects with the long longitudinal groove 112. According to one embodiment the long latitudinal groove 114 is aligned substantially parallel with edges 184 of the tread element 110. In another embodiment, the long latitudinal groove 114 extends the entire length of the tread element 110. The long longitudinal groove 112 and the long latitudinal groove 114 divide the tread element 110 into four sections 116.

Additionally, located on both sides of the long longitudinal groove 112 are short parallel longitudinal grooves 122. The short parallel longitudinal grooves 122 have a shorter length than the long longitudinal groove 112. In one embodiment, the tread element 110 includes two short parallel longitudinal grooves 122 spaced substantially equally on either side of the long longitudinal groove 112. Short parallel latitudinal grooves 124 are located on both sides of the long latitudinal groove 114. The short parallel latitudinal grooves 124 have a shorter length than the long latitudinal groove 114. In one embodiment, the short parallel latitudinal grooves 124 are spaced substantially equally on either side of the long latitudinal groove 114.

In an embodiment having two short parallel longitudinal grooves 122 and two short parallel latitudinal grooves 124, the short parallel grooves 122, 124 divide the tread element 110 into an inner rectangular area 126 and an outer rectangular area 128. The inner rectangular area is further divided into inner tread blocks 132 by the long longitudinal groove 112 and the long latitudinal groove 114. The long longitudinal groove 112 and the long latitudinal groove 114 also divide the outer rectangular area 128 into outer tread blocks 148.

In an additional embodiment, the tread element 110 may include additional short parallel longitudinal grooves 122 and/or additional short parallel latitudinal grooves 124. Additional short parallel longitudinal grooves 122 and/or additional short parallel latitudinal grooves 124 further divide the inner rectangular area 126 into additional inner tread blocks 132 and/or additional outer tread blocks 148.

The tread element 110 has a width, W, and a length, L. The width, W, and length, L, may be substantially similar, in which case the tread element 110 is a square. According to one embodiment, the width, W, and the length, L, are approximately five to fifteen millimeters.

The long latitudinal groove 114 in the tread element 110 is shown to have a depth, D. According to one embodiment, a depth of the grooves 112, 122, 124 are substantially similar to the depth, D, of the long latitudinal groove 114. An overall height of the tread element is a height, H. The depth, D, of the long latitudinal groove 114 may be a fraction or substantially all the entire height, H, of the tread element 110. In one embodiment, the height, H, of the tread element 110 is approximately one to five millimeters, and the depth, D, of the long latitudinal groove 114 is approximately one to two millimeters.

The tread can be made of any suitable composition such as rubber or other synthetic which will inhibit slipping where the tread configuration substantially enhances the non-skid characteristics of the composition.

FIG. 2 is a perspective view of an array of exemplary tread elements having improved slip-resistance according to one embodiment of the disclosure. An array 220 of the tread elements 110 has an axis 280 and an axis 282. The tread elements 110 include the long longitudinal groove 112 oriented along an axis 142. The tread elements 110 also include the long latitudinal groove 114 oriented along an axis 144. According to one embodiment, the axis 280 of the array 220 is aligned substantially with the axis 144 of each of the tread elements 110 of the array 220. Additionally, both the axis 280 and the axis 282 may be aligned as shown in FIG. 2 with the axis 144 and the axis 142, respectively.

The exemplary tread configuration described above may be embedded in any structure for improved slip-resistance. For example, a sole of a shoe may include the exemplary tread configuration. Shoes that include the exemplary tread configuration have increased friction between the sole of the shoe and the floor. Increased friction decreases the number of slip-and-fall incidents by improving an employee's ability to remain balanced in slippery hazards. Orientation of the axis 280 and the axis 282 may vary in a shoe. According to one embodiment, the axis 280, along which the long latitudinal groove 114 of each of the tread elements 110 align, is oriented substantially parallel with the direction of travel of the shoe outer sole 205. According to another embodiment, the axis 280 may be aligned approximately forty-five degrees out of alignment with the direction of travel of a shoe.

An exemplary tread configuration as described above has improved slip-resistance. The exemplary tread configuration may be embedded in, for example, an outer sole of a shoe to reduce slip-and-fall incidents resulting from slippery hazards in a workplace or home environment. The exemplary tread configuration may be integrated into additional items for improved traction. For example, the exemplary tread configuration may be integrated into tires, doormats, and crutch tips.

Although the present disclosure and its advantages have been described in detail, it should be understood that various changes, substitutions and alterations can be made herein without departing from the technology of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A tread element, comprising:
a tread element unit having a length and a width with a long longitudinal groove extending along a substantial length of the tread element unit;
a long latitudinal groove extending along a substantial width of the tread element unit;
at least two short longitudinal grooves extending a fraction of the length of the tread element unit and aligned substantially parallel to the long longitudinal groove, at least one of the at least two short longitudinal grooves being on each side of the long longitudinal groove; and
at least two short latitudinal grooves extending a fraction of the width of the of the tread element unit and aligned substantially parallel to the long latitudinal groove, at least one of the at least two short latitudinal grooves being on each side of the long latitudinal groove.

2. The tread element of claim 1, in which a depth of the long longitudinal groove and a depth of the long latitudinal groove are substantially the same.

3. The tread element of claim 2, in which the depth of the long longitudinal groove and the depth of the long latitudinal groove are in a range of about one to two millimeters.

4. The tread element of claim 1, in which the length of the tread element unit and the width of the tread element unit are substantially the same.

5. The tread element of claim 4, in which the length of the tread element unit and the width of the tread element unit are in a range of about five to fifteen millimeters.

6. The tread element of claim 1, in which a height of the tread element unit is in a range of about one to five millimeters.

7. The tread element of claim 1, in which the long latitudinal groove is substantially perpendicular to the long longitudinal groove.

8. A tread element, comprising:
at least two inner tread blocks; and
at least four outer tread blocks adjacent to the at least two inner tread blocks and arranged to substantially surround the at least two inner tread blocks.

9. The tread element of claim 8, in which the at least two inner tread blocks are aligned in a rectangular pattern.

10. The tread element of claim 8, in which the at least four outer tread blocks are aligned in a rectangular pattern.

11. The tread element of claim 8, in which the tread element is incorporated into a tread configuration having multiple tread elements.

12. The tread element of claim 11, in which the tread element is integrated into at least one of a shoe outer sole, a tire, a doormat, and a crutch tip.
